(19) United States
(12) Patent Application Publication
(10) Pub. No.: US 2008/0060384 A1
(43) Pub. Date: Mar. 13, 2008

(54) GLASS HEATING AND COOLING DEVICE

(75) Inventors: Randy L. Mackey, Bend, OR (US); Michael P. Boyle, Bend, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: GLAS-WELD SYSTEMS, INC., Bend, OR (US)

(21) Appl. No.: 11/850,559

(22) Filed: Sep. 5, 2007

Related U.S. Application Data
(60) Provisional application No. 60/842,846, filed on Sep. 8, 2006.

(51) Int. Cl. C03B 23/20

(52) U.S. Cl. 65/29.19; 65/162

(57) ABSTRACT

Embodiments of the present invention provide a device for controlling the temperature of glass by temporarily mounting the device on the glass and causing the flow of thermal energy into or out of the glass to raise or lower the temperature of the glass. In an embodiment, there is provided a windshield heating and cooling device that may heat and/or cool a windshield in the area of damage to be repaired. Such a device may have a thermoelectric control module, one or more heat sinks, and an attachment mechanism for attaching the device to a glass member to bring the device into thermal contact with the glass member.

### CROSS REFERENCE TO RELATED APPLICATIONS

The present application claims priority to U.S. Provisional Patent Application No. 60/842,846, filed Sep. 8, 2006, entitled “Windshield Heating and Cooling Device,” the entire disclosure of which is hereby incorporated by reference in its entirety.

### TECHNICAL FIELD

Embodiments of the present invention relate to a device for heating and/or cooling glass such as a windshield, and in particular to a device for heating and/or cooling a windshield to facilitate repair of the windshield.

### BACKGROUND

The repair of small holes and cracks in glass, such as windshield glass, may be accomplished by filling the holes or cracks with a clear resin or epoxy type chemical to remove air from the space created by the holes or cracks. Damage to a glass windshield surface caused by a stone or other object striking the glass may obscure the view through the windshield causing an unsuitable, and even unsafe, condition. In certain situations, the majority of the damage may be below the surface in which small amounts of air may be trapped. The trapped air may cause a refraction of the light passing through the glass. Thus, a general goal of glass repair is often to remove the trapped air and/or to fill the void with a clear material to stop the refraction of light and to stop the spread of the break. The success of such repair operations is enhanced by maintaining the glass being repaired at a suitable temperature.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a perspective view of a windshield heating and cooling device in accordance with various embodiments of the present invention;

FIG. 2 illustrates a front view of a windshield heating and cooling device attached to the surface of a windshield in accordance with various embodiments of the present invention;

FIG. 3 illustrates a side view of a windshield heating and cooling device in accordance with various embodiments of the present invention;

FIG. 4 illustrates a top view of a windshield heating and cooling device in accordance with various embodiments of the present invention; and

FIG. 5 illustrates an exploded view of a windshield heating and cooling device in accordance with various embodiments of the present invention.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” means A or B. For the purposes of the description, a phrase in the form “A and/or B” means “(A), (B), or (A and B)”. For the purposes of the description, a phrase in the form “at least one of A, B, and C” means “(A), (B), (C), (A and B), (A and C), (B and C), or (A, B and C)”. For the purposes of the description, a phrase in the form “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide a device for controlling the temperature of glass by temporarily mounting the device on the glass and causing the flow of thermal energy into or out of the glass to raise or lower the temperature of the glass. In an embodiment, there is provided a windshield heating and cooling device that may heat and/or cool a windshield in the area of damage to be repaired. In an embodiment, a windshield heating and cooling device may be utilized to maintain a relatively constant windshield temperature, in particular, within proximity of the area of damage to be repaired.

In an embodiment, a device for controlling the temperature of glass, in particular a windshield heating/cooling device, may comprise a heat sink, such as a thermoelectric control (TEC) module with a heat sink and fan on one side of the module and a solid heat sink on the other side of the module, a power supply cord, a power/function switch, and suction cups or other attachment members to attach the device to a windshield. The provision of heating and cooling functions in an integrated device enables a user to attach a single device to glass and raise, lower, and/or maintain the temperature of the glass in particular in the area of the damage to be repaired without having to juggle multiple devices or substantially reconfigure a single device.

In an embodiment, a device of the present invention may be used to control the temperature of glass, for example to repair the glass, by attaching the device to glass, either opposite the side of the damage to be repaired or on the side of the damage to be repaired and in proximity of the damage to be repaired, and powering on the device to begin the flow of thermal energy into or out of the glass to be repaired using a first heat sink and, optionally a second heat sink, in conjunction with a TEC module. When the device is used in conjunction with the repair of glass, once the glass is at or near the desired temperature, the damage may be repaired with a suitable epoxy or other compound, and the glass may then be allowed to return to a baseline temperature.

Thus, in an embodiment, there is provided a device for controlling temperature of a glass member, comprising a thermoelectric control module coupled to a power source adapted to cause the thermoelectric control module to transfer thermal energy between the thermoelectric control module and the glass member, a first heat sink in thermal contact with the thermoelectric control module and having a surface area adapted to transfer thermal energy between the first heat sink and surrounding air, and an attachment member for attaching the device to the glass member and bringing the thermoelectric control module into thermal contact with the glass member.

In an embodiment, a device of the present invention may be used on a windshield whether it is installed in a vehicle or uninstalled. In an embodiment, a device of the present invention may be attached to either side of a windshield. In other words, in an embodiment, a device of the present invention may be attached to the interior of a windshield (facing the interior of the vehicle), or on the exterior of the windshield (facing the exterior of the vehicle). For the purposes of describing embodiments of the present invention, the term “vehicle” is intended to be used broadly to refer to any device of conveyance that uses or may use a windshield, including cars, trucks, airplanes, boats, personal watercraft, recreational vehicles, etc.

While embodiments of the present invention are generally described with reference to use on a windshield, it should be appreciated that use on glass, in general, for heating/cooling or maintaining the temperature of the glass is contemplated. In particular, an embodiment of the present invention may be used to control the temperature of a glass member to which the device is attached, and may, in an embodiment, be used in conjunction with repair of the glass member. In embodiments, a device may be used in conjunction with any suitable type of glass, such as tempered glass, laminated glass, insulated glass, safety glass, vehicle glass, etc.

In accordance with an embodiment of the invention, a TEC module creates a heat flux between materials or components in a device, and provides a relatively hot side and a relatively cold side, the designation of which may be reversed, depending on the polarity of the TEC module. A TEC module provides a thermal energy differential from an electric voltage utilizing the Peltier effect. The Peltier effect occurs when a current is passed through two dissimilar metals or semiconductors (n-type and p-type) that are connected to each other at two junctions (Peltier junctions). The current drives a transfer of heat from one junction to the other: one junction cools off while the other heats up. In an embodiment, an exemplary TEC module may be PT2-12-30 from the Melcor Company, although other suitable TEC modules may used as well.

In embodiments, a TEC module is in thermal contact with one or more heat sinks to provide a flow of thermal energy in the desired directions. In an embodiment, a heat sink may be a conductive metal device with, for example, a comb or fin arrangement. In embodiments, a comb or fin arrangement typically has a first thermal contact region or plate to which are coupled a series of fins to provide a relatively high surface area for transfer of thermal energy to surrounding air. The high thermal conductivity of the metal combined with a large surface area generally results in the rapid transfer of thermal energy to the surrounding air. When dissipating hear, this function helps cool the heat sink and the material(s) with which it is in direct thermal contact. In an embodiment, a heat sink, such as a heat sink having a fin/comb arrangement, may be further provided with one or more channels, such as microchannels, for the flow of fluids, such as cooling fluids, to increase the heat dissipation capability of the heat sink. In an embodiment, a fan used in conjunction with the heat sink may improve the transfer of thermal energy from the heat sink to the air. In an embodiment, a fan may aid the dissipation of thermal energy by a heat sink by providing increased airflow over the heat sink and thus maintaining a larger temperature gradient by replacing the warmed or cooled air more quickly than passive convection alone. In an embodiment, cooling may be furthered by circulating a coolant about and/or in the fins, heat sink or other portion.

In an embodiment, a fan, such as described above, may be operated in the opposite direction to draw-in air from the outside and force air onto and along the metal fins/comb. In embodiments, a fan may be operated in one or both directions and may be operated at a single speed or at variable, selectable speeds, as desired.

In an embodiment, a heat sink may be a solid heat sink. Such an element may be used to transfer heat between a TEC module and another material in thermal contact with the solid heat sink, such as a windshield as contemplated by embodiments of the present invention. For the purposes of describing embodiments of the present invention, the term “thermal contact” refers to the relationship between two elements that are in sufficient proximity to transfer thermal energy between them directly or indirectly. For the purposes of describing embodiments of the present invention, the term “glass member thermal interface” refers to the junction between a heat sink and a glass member to provide thermal contact, whether the elements are in direct or indirect contact.

In an embodiment, a heat sink may be constructed of a thermal conductor, such as copper, aluminum alloy, etc. In an embodiment, the portion of the heat sink that interfaces with the glass may be formed to the contour of the glass or of a flexible material which may conform to the glass contour in order to improve the transfer of thermal energy between the heat sink and the glass.

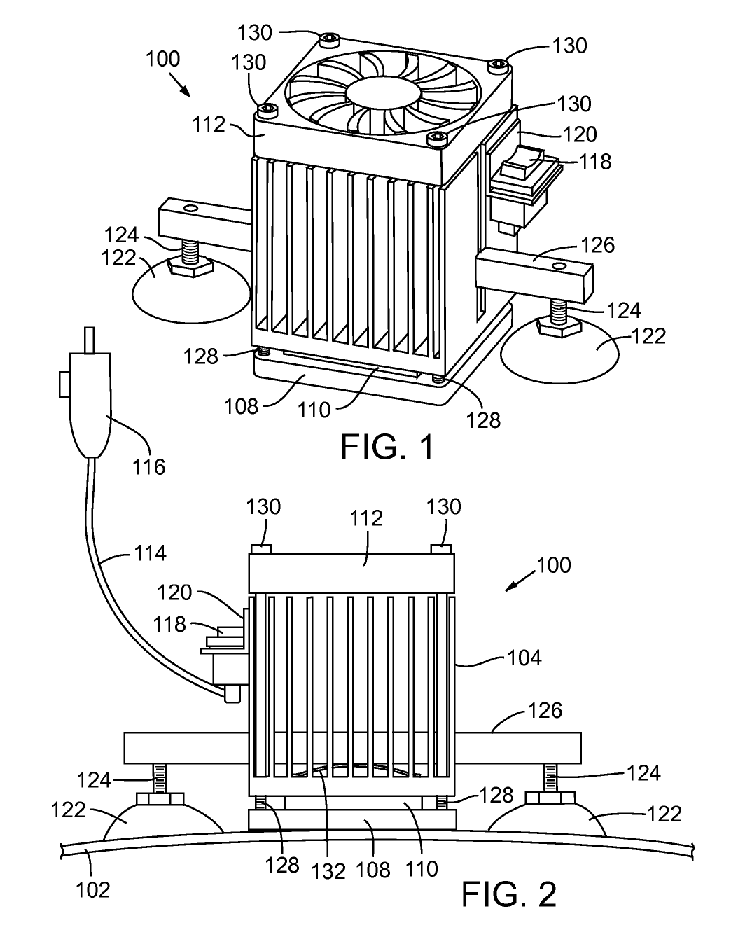

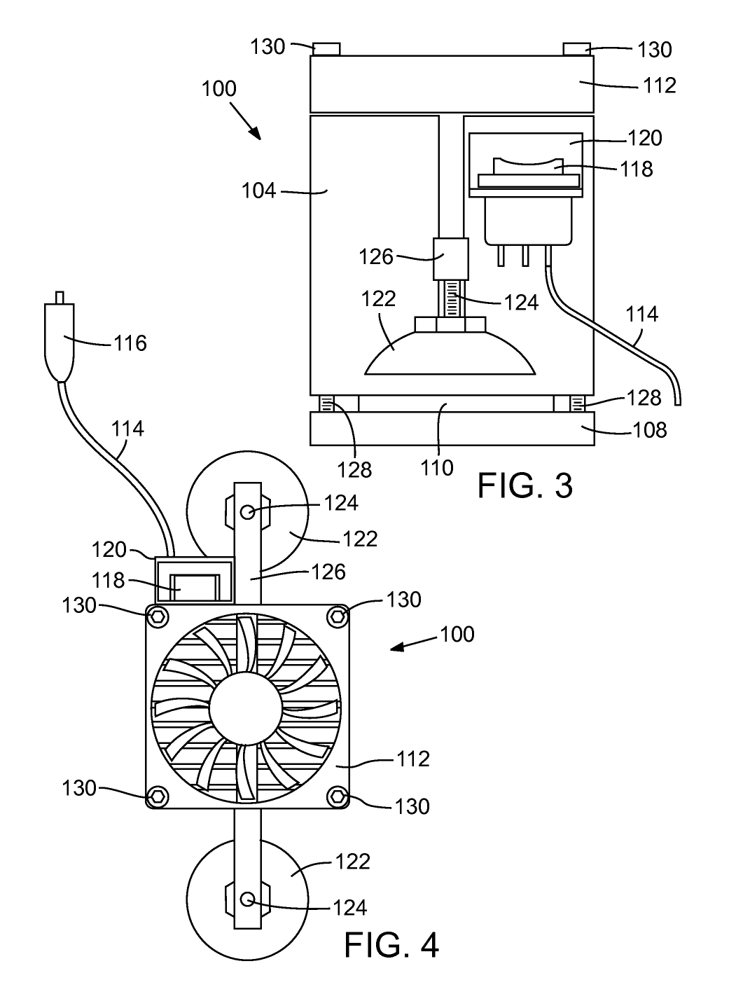

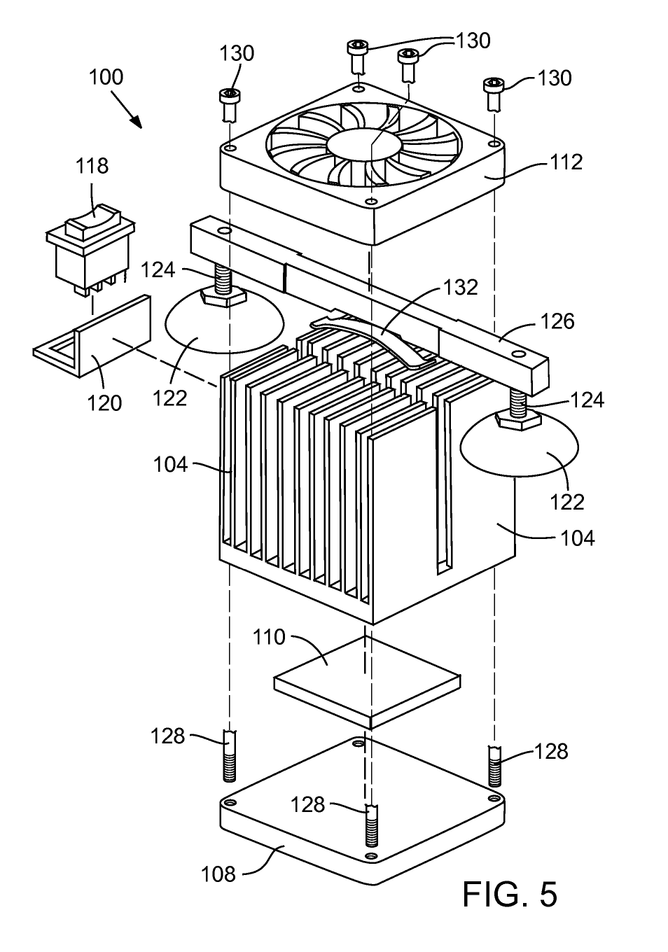

FIGS. 1, 2, 3, 4, and 5 illustrate a windshield heating and cooling device 100 in accordance with various embodiments of the present invention. In an embodiment, device 100 may be attached to glass 102 (see FIG. 2) in the area of damage to be repaired to heat and/or cool that area, or to maintain the temperature of the glass at a relatively constant temperature. Device 100 has a thermoelectric control (TEC) module 110, such as a Peltier device or other such heat pump device. Device 100 also has a first heat sink 104 and a second heat sink 108, both in thermal contact with TEC module 110, wherein first heat sink 104 has a comb or fin arrangement and second heat sink 108 is a solid heat sink. In an embodiment, second heat sink 108 may be constructed of one or more plates fabricated from the same or different thermally conductive materials. In an embodiment, first heat sink 104 may be further coupled to a fan 112, which assists in dissipating thermal energy from heat sink 104, or in drawing air onto the fins of heat sink 104. In embodiments, a fan may be any of a variety of suitable fans regardless of the number of blades or the amount of airflow produced by the fan.

While FIGS. 1, 2, 3, 4, and 5 illustrate separable first and second heat sinks (104, 108), in an embodiment, a single heat sink may be coupled to TEC module 110, whether that single heat sink is a solid heat sink or has a fin/comb arrangement.

In an embodiment, as needed, power to TEC module 110 and fan 112 may be provided through a power cord 114 having any of a variety of electrical connectors, such as connector 116. Connector 116 may be used to couple device 100 with a suitable power source. Device 100 further has a switch 118, such as multi-position switch, or other actuating element coupled to power cord 114 to control the use of power and/or to control the selected function(s) of device 100. Switch 118 may be mounted to device 100 using any suitable mounting means such as mounting plate 120.

In an embodiment, a suitable actuating element (switch, dial, etc.) may be used to select the state of the device (on/off) and additionally, in an embodiment, a particular function of the device (heating/cooling).

In an embodiment, a switch, such as a multi-position switch, may be operated to turn the device on and off and to change the polarity of the device to thus select a heating or cooling function. In an embodiment, a spring actuated snap switch may be used such that the switch must be held in a depressed state in order to deliver power (and thus heating or cooling) to the device and thus provide a mechanism to ensure the windshield is not over heated or over cooled. In an alternative embodiment, a different actuator may be used instead of a switch, such as a dial or buttons. For example, when using a dial, rotation of the dial a first distance may turn the device on, and then a pointer, or something similar, may indicate a desired temperature within a suitable temperature range of operation of the device. In such an embodiment, reversing the dial back to the starting position may turn the device off.

In an embodiment, the thermoelectric control module and fan may be powered by an electric current, such as a direct current system, a twelve volt system with an adapter plug for insertion in a power outlet of a vehicle (such as a cigarette lighter-type outlet), a separate battery system, or a standard 110-120 volt system, etc.

In an embodiment, a windshield may be heated (or cooled) to a temperature in the range from about 30° F. to about 250° F., and in one embodiment a preferred range is about 70° F. to 80° F. for repair of the windshield. In an embodiment, the device may be configured with a temperature sensor and temperature gauge to provide an indication of the current temperature of the windshield. Further, the heating and/or cooling of the device may be controlled by a microcontroller coupled to the sensor to enable the device to be preset to a desired temperature and/or to enable the maintenance of a suitable temperature within a relatively small amount of fluctuation.

In an embodiment, an attachment member such as suction cups 122 may be provided on a support bar 126 or other support structure to attach device 100 to glass 102. In an embodiment, suction cups 122 may be coupled to support bar 126 by threaded member 124. Threaded member 124 may allow for adjusting the distance of suction cups 122 from support bar 126 to bring suction cups 122 into contact with a glass surface and to account for the different shapes of the glass surfaces to which device 100 may be attached. Further, in an embodiment, suction cups 122 may be attached rigidly to threaded member 124, or alternatively, suction cups 122 may be flexibly attached to threaded member 124 such that suction cups 122 are provided with a range of lateral movement to account for different glass surfaces, whether uniform or non-uniform, convex or concave, etc. In an alternative embodiment, threaded member 124 (or other suitable connecting structure) may be mounted to support bar 126 such that threaded member 124 is provided with a range of lateral movement to allow for variable positioning of suction cups 122.

While suction cups 122 are shown attached to support bar 126 by threaded member 124, other means for coupling may be utilized such as spring-loaded telescoping tension bars. In addition, in an embodiment, instead of a single support bar 126, separate support structures may be provided for each suction cup 122 or other attachment member.

A support bar (such as support bar 126) may be provided with a variety of features to ensure proper alignment of the support bar and the associated attachment members. In an embodiment, a support bar may be curved to provide better alignment with a curved glass member, whether convex or concave. In another embodiment, a support bar may have a substantially u-shaped construction such that at the ends, the support bar may turn toward the suction cups or other attachment members to bring the suction cups or other attachment members in closer proximity of the glass surface to which the device is intended to be attached.

While in the figures suction cups are shown, other attachment members may be utilized in addition to or instead of suction cups, such as adhesive, clamps, etc.

In an embodiment, support bar 126 may rest on, at least in part, a separating element, such as spring 132. In an embodiment, spring 132 may be constructed of a poor thermal conductor to limit the amount of heat transfer to support bar 126. Further, support bar 126 may move freely within heat sink 104, or, in embodiments, one or more additional structures may be provided to secure the location of support bar 126 within heat sink 104 or in another location.

While FIG. 2 illustrates a preferable arrangement in which suction cups 122 and heat sink 108 contact glass 102, it is possible in embodiments that heat sink 108 is merely brought into close proximity of glass 102. In addition, in an embodiment, an attachment member (such as suction cups 122) is not necessary when gravity, or a force provided for example by an individual, may suffice to hold device 100 in a suitable location.

The components of device 100 may be coupled together in any suitable fashion such as using rods 128 extending from fan 112 to heat sink 108. In an embodiment, rods 128 may be threaded at one end for securing to corresponding threads in heat sink 108 and may have securing heads 130 at the other end to facilitate a secure connection of the components. In embodiments, other arrangements may be utilized to couple the components of the device.

Methods of use of embodiments of the invention are also provided. In an embodiment, a method of controlling the temperature of a glass member for repair of the glass member is provided comprising attaching a device to the glass member, the device comprising a thermoelectric control module coupled to a power source adapted to cause the thermoelectric control module to transfer thermal energy between the thermoelectric control module and the glass member, a first heat sink in thermal contact with the thermoelectric control module and having a surface area adapted to transfer thermal energy between the first heat sink and surrounding air, and an attachment member for attaching said device to the glass member and bringing said thermoelectric control module into thermal contact with the glass member, and providing power to the thermoelectric control module to control the temperature of the glass member.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A device for controlling temperature of a glass member, comprising:
a thermoelectric control module coupled to a power source adapted to cause the thermoelectric control module to transfer thermal energy between the thermoelectric control module and the glass member;
a first heat sink in thermal contact with the thermoelectric control module and having a surface area adapted to transfer thermal energy between the first heat sink and surrounding air; and
an attachment member for attaching said device to the glass member and bringing said thermoelectric control module into thermal contact with the glass member.

2. The device of claim 1, further comprising a second heat sink in thermal contact with the thermoelectric control module on a side of the thermoelectric control module opposite the first heat sink, said second heat sink comprising one or more thermally conductive plates, said second heat sink being in thermal contact with the glass member and providing indirect thermal contact of the thermoelectric control module with the glass member.

3. The device of claim 1, wherein first heat sink comprises a fin or comb structure.

4. The device of claim 1, further comprising a fan coupled to said first heat sink.

5. The device of claim 1, further comprising a multi-position actuating element for selecting a power state and function of the device.

6. The device of claim 5, wherein said multi-position actuating element is a dial or a switch.

7. The device of claim 1, wherein said attachment member comprises one or more suction cups.

8. The device of claim 7, wherein each of said one or more suction cups are mounted on one or more support structures.

9. The device of claim 8, wherein each of said one or more suction cups are mounted on one or more support structures by a threaded member to facilitate adjustment of distance between each of said one or more suction cups and said one or more support structures.

10. The device of claim 8, wherein each of said one or more suction cups are flexibly mounted on one or more support structures to facilitate lateral movement of each of said one or more suction cups.

11. The device of claim 8, wherein said one or more support structures are adjustable to facilitate attachment of said one or more suction cups to a glass member having a flat, convex, or concave surface.

12. The device of claim 1, wherein the power source includes a power cord coupled to the device at a first end and having an electrical connector at a second end.

13. The device of claim 12, wherein said electrical connector comprises an electrical connector for coupling to an electrical outlet of a vehicle.

14. A device for controlling temperature of a glass member, comprising:
a thermoelectric control module coupled to a power source adapted to cause the thermoelectric control module to transfer thermal energy between the thermoelectric control module and a first heat sink and a second heat sink, said first heat sink in thermal contact with the thermoelectric control module and having a fin or comb structure adapted to transfer thermal energy between the first heat sink and surrounding air, said second heat sink in thermal contact with the thermoelectric control module and comprising one or more thermally conductive plates and being in thermal contact with the glass member; and
an attachment member for attaching said device to the glass member and bringing said second heat sink into thermal contact with the glass member.

15. The device of claim 14, further comprising a fan coupled to said first heat sink.

16. The device of claim 14, wherein said attachment member comprises one or more suction cups.

17. The device of claim 16, wherein each of said one or more suction cups are mounted on one or more support structures.

18. The device of claim 17, wherein each of said one or more suction cups are mounted on one or more support structures by a threaded member to facilitate adjustment of distance between each of said one or more suction cups and said one or more support structures.

19. The device of claim 17, wherein each of said one or more suction cups are flexibly mounted on one or more support structures to facilitate lateral movement of each of said one or more suction cups.

20. The device of claim 17, wherein said one or more support structures are adjustable to facilitate attachment of said one or more suction cups to a glass member having a flat, convex, or concave surface.

21. A method of controlling the temperature of a glass member for repair of the glass member, comprising:
attaching a device to the glass member in proximity to damage to be repaired, the device comprising a thermoelectric control module coupled to a power source adapted to cause the thermoelectric control module to transfer thermal energy between the thermoelectric control module and the glass member, a first heat sink in thermal contact with the thermoelectric control module and having a surface area adapted to transfer thermal energy between the first heat sink and surrounding air, and an attachment member for attaching said device to the glass member and bringing said thermoelectric control module into thermal contact with the glass member; and
providing power to the thermoelectric control module to control the temperature of the glass member.
